(19) United States
(12) Patent Application Publication
(10) Pub. No.: US 2020/0360736 A1
(43) Pub. Date: Nov. 19, 2020

(54) PORTABLE AIR TREATMENT DEVICE AND METHOD FOR SUPPLYING FILTERED AIR TO A PERSON

(71) Applicant: APICS B.V., Baam (NL)

(72) Inventors: Antonius Willem VERBURG, BAARN (NL); Joannes Theodorus Josephus VAN WOERKUM, BAARN (NL)

(21) Appl. No.: 16/638,202

(22) PCT Filed: Aug. 15, 2018
(86) PCT No.: PCT/NL2018/050543

§ 371 Date: Feb. 11, 2020

(30) Foreign Application Priority Data
Aug. 15, 2017 (NL) 2019418

(51) Int. Cl. A62B 18/00; A62B 18/10; A62B 23/02

(52) U.S. Cl. CPC A62B 18/006; A62B 23/02; A62B 18/10

(57) ABSTRACT

The present invention provides a portable air treatment device to supply filtered air to a person. The device comprises an air pump to provide a flow of air, a filter device to filter the flow of air, a breathing mask configured to supply the flow of air to the person, and a control unit configured to control the pump for adjusting the flow of air. The control unit is configured to control the pump for adjusting the flow of air in order to maintain a desired pressure difference between the pressure in the interior of the breathing mask and the ambient air. The present invention further provides a method for supplying filtered air to a person with a portable air treatment device, comprising the steps of: detecting the pressure difference between the interior of the breathing mask and the ambient air, controlling, with a control unit, the air pump to provide a flow of air in dependence of the pressure difference in order to maintain a desired pressure difference, filtering the flow of air, and guiding the flow of air towards the interior of the breathing mask.

The present invention relates to a portable air treatment device to supply filtered air to a person. The device comprises an air pump to provide a flow of air, a filter device to filter the flow of air, a breathing mask configured to supply the flow of air to the person, and a control unit configured to control the air pump for adjusting the flow of air.

These portable air treatment devices are configured to clean an incoming flow of air and to feed this flow to a person using the device. These devices are typically used by persons that need to work or live in contaminated air, for example contaminated with viruses. These devices are mobile and may be carried around by the person, to improve the flexibility thereof.

The invention further relates to a method for supplying filtered air to a person with a portable air treatment device, comprising the steps of filtering, with the filtration device, a flow of air, and guiding the flow of air towards the interior of the breathing mask.

WO 2011/006206 discloses a breathing apparatus with a mask, which is configured to supply filtered air to a user. The mask is adapted to substantially surround at least the mouth or nostrils of the user. The apparatus comprises a neck component, which is attached to the mask and which comprises a flow generator. This flow generator is configured to receive unfiltered air, to filter the unfiltered air and to provide filtered air towards the mask.

With the known apparatus, the amount of provided air is responsive to the breath of the patient and also the responsiveness is user adjustable as well. The apparatus therefor comprises a flow or pressure sensor. A rise in airflow, at the start of the inhalation, is used to indicate the start of the inhaling and a target motor speed of the flow generator may be set at a value that corresponds to the breathing effort.

The known breathing apparatus, however, has the disadvantage that the air flow, provided by the flow generator, varies during the breathing cycle. Accordingly, the air pressure in the mask varies as well. During natural breathing of the person, without using any apparatus, these values are constant. Due to the fluctuations with the apparatus, breathing through the apparatus will feel less natural for the user and will give rise to discomfort.

In FR 2 705 899 A1, a breathing mask is disclosed, which is configured to cover the mouth and nose of a person. Such breathing masks have the disadvantage that they are uncomfortable to wear, for example because they hinder any conversation of the person or because their appearance may look daunting.

In US 2007/175473 A1, a high flow therapy system is disclosed for delivering a flow or air to nostrils of a person for the treatment of sleep apnoea. This system comprises a non-sealing nasal mask, which, for example, allows the introduction of pressure sensors in between the nostrils and cannulae of the nasal mask, in order to measure a pressure in the nostrils.

This non-sealing mask, however, brings the disadvantage that it allows the person to breath in bleed air, entering the nose through the spacing between the cannulae and the nostrils. When the person is situated in a toxic environment and uses the mask in combination with a filtering device, this bleed air is not filtered, which means that the person still breaths unfiltered and toxic air.

It is an object of the invention to provide a portable air treatment device that lacks or reduces one or more of the above-mentioned drawbacks or at least to provide an alternative portable air treatment device.

The present invention provides a portable air treatment device to supply filtered air to a person, comprising an air pump to provide a flow of air, a filter device to filter the flow of air, a breathing mask configured to supply the flow of air to the person and a control unit configured to control the pump for adjusting the flow of air. The air treatment device comprises a pressure sensor to transmit a signal that is representative for a pressure difference between the interior of the breathing mask and the ambient air, and the control unit is configured to control the pump for adjusting the flow of air in order to maintain a desired pressure difference between the pressure in the interior of the breathing mask and the ambient air.

As a result of inhaling of the person, the pressure in the interior of the mask may decrease. In response to the decreased pressure in the interior of the mask, the control unit determines that an increased flow of air towards the mask is required in order to increase the pressure in the interior of the mask and to reach the desired pressure difference between the interior of the mask and the ambient air.

With the pressure difference being kept substantially constant, a high amount of comfort is provided to the person that uses the device. The advantage is provided that, for him, it would appear that he is not breathing through a device with a mask, but it would appear as if he is normally breathing, for example through his nose.

When the person is exhaling, however, the pressure in the interior of the mask increases again. The control unit is furthermore configured to detect this increase in pressure and to control the pump in order to decrease the flow of air to the person. When the air flow is substantially reduced, the air pump will consume less or even no energy. Advantageously, the battery lifetime will be increased.

Generally, the device is configured to be used in environments in which a person would like to breathe filtered air. Applications of the portable air treatment device according to the invention may therefore be found in traffic, for example in cities with a high smog level. Yet another application may be found in construction working, in which people need to work in dust-rich environments.

The air treatment devices that are known from the prior art comprise relatively large pumps, with a high moment of inertia. Accordingly, acceleration and deceleration of the pump would happen relatively slowly. These pumps from prior art work optimally when they operate at a fixed velocity, such that they constantly supply the air flow.

The air pump in the device according to the present invention may be designed to accelerate and decelerate rapidly and to operate at a high rotational speed, for example in the range of 2.000-40.000 rpm. A response time of the pump, between providing a low amount of air and a high amount of air, is thereby lowered. As such, the pump may be controlled more accurate and the pressure difference may be controlled more accurately as well.

The pressure sensor may be arranged in the interior of the mask, but may preferably be arranged at a distance from the mask, which provides the advantage that the mask may be made lighter due to the absence of a pressure sensor therein. With the pressure sensor, the pressure in the interior of the mask is measured, preferably in a continuous manner. The control unit is electronically connected to the pressure sensor, configured to obtain the measured pressure values and to determine, on the basis of these measured pressure values, the pressure in the interior of the breathing mask

The device may comprise one or more measuring heads for measuring a corresponding amount of pressure differences.

The control unit may be configured to control the air pump on the basis of field-oriented control, with which electric currents through the coils of an electric motor of the pump are controlled on the basis of the actual position of the rotor with respect to the coils. This field-oriented control provides that the current in the coils is only applied when it will optimally result in a magnetic force on the rotor. Accordingly, the power of the motor is optimally released when, for example, the control unit controls the pump to increase the flow of air. The field-oriented control can be used to reduce a noise level and energy consumption of the air pump with respect to the air pumps in the known breathing devices.

The control unit is, in response to the inhaling and exhaling of the person, configured to maintain a desired pressure difference between the pressure in the interior of the breathing mask and the ambient air. The rapid acceleration and deceleration of the pump may thereby provide that the pressure difference may be accurately controlled.

Preferably, the control unit is configured to continuously compare signals from the pressure sensor, in order to compare the actual pressure difference between the interior of the mask and the ambient air with the desired pressure difference between the interior of the mask and the ambient air. The control unit is further configured to continuously control the pump in order to maintain the pressure difference between the interior of the mask and the ambient air at the desired level.

With the device according to the invention, a portable breathing apparatus may be achieved which has a compact design and which can be used comfortably by a person for supplying filtered air to be breathed.

In an embodiment, the control unit is configured to set the desired pressure difference such, that the pressure in the interior of the mask is higher than that of the ambient air. It is thereby prevented that air from the surroundings, which may be contaminated, is sucked into the interior of the mask.

In an embodiment, the device is configured to keep the pressure difference between the pressure in the interior of the mask and the ambient air in the range of 1-6 hPa, preferably in the range of 3-5 hPa, for example at 4 hPa.

With the device according to the invention, the time between the start of inhaling and the point at which the air flow is fed to the person may be under 0.1 seconds. This delay time is sufficiently short, that the person will not note it. A typical flow velocity of the flow of air, that will be supplied by the device, has been found around 0.2 litres per second during inhaling of the person. However, the flow of air is actually controlled on the basis of the pressure difference and the resulting flow velocity may depend on the person and his activity.

The breathing mask is adapted to be worn by the person in order to receive the flow or air from the device. An example of a breathing mask is a mask that covers the nose and mouth of the person, so that he may inhale through either his nose or his mouth. The breathing mask may further comprise fixing means, in order to secure the mask to the head of the person.

The filter device of the air treatment device according to the present invention is configured to remove contaminants from the flow of air, before the air is provided to the person. The filter device may be arranged upstream of the air pump, such that contaminated air is filtered before entering the air pump, in order to prevent contamination of the pump. In an alternative embodiment, however, the filter device may be arranged downstream of the pump.

The filter device comprises one or more filter elements through which the flow of air is guided. An example of such a filter element is an activated carbon filter element, which is configured to remove gaseous contaminants, such as oil vapours or hydrocarbons from the air. Another example of such a filter element is a HEPA-filter (High Efficiency Particulate Arrestance), which is an air filter that is configured to remove solid and liquid particles, such as particulate matter (PM) or oil droplets from the flow of air.

In various embodiments of the air treatment device, various types of filter elements may be used or may even be combined into a single filter device, depending on the desired filtering capabilities. In a further embodiment, the filter device is exchangeable, so that the person using the device may mount the appropriate filter elements in the filter device, depending on the surroundings in which he has to use the air treatment device.

In an embodiment, the filter device may comprise an identification device, such as a QR-scanner. With the identification device, identifier elements, such as QR-codes, on the filter elements may be scanned and the filter elements may be identified. By identifying the filter elements, the control unit may determine which type of filter element is present in the filter device, and may adapt the controlling of the air pump on the basis of the identified type of filter element.

In an embodiment of the device, the breathing mask is a nasal mask, preferably a sealing nasal mask, that is configured to be at least partially inserted in the nostrils of the person. Such a nasal mask is not configured to cover the mouth of the person and is therefore substantially smaller and lighter than breathing masks that are adapted to cover both nose and mouth. A sealing nasal mask thereby is a specific type of nasal mask that is configured to abut the nostrils of the person, such that a fluid-tight connection may be achieved between them, without having the risk of leakage between the mask and the nostrils.

The sealing between the nostrils and the nasal mask is configured to prevent the leakage of air between them and provides that only filtered air is delivered to the person. No unfiltered bleed air can thereby enter the nose of the person and the breathing of filtered, clean air is safeguarded.

The nasal mask has the advantage that, because the mouth is left free, the person is allowed to talk when he has the mask on, without being hindered by a mask covering his mouth. Additionally, the nasal mask allows person to eat and drink while they use the mask to breathe through.

A further advantage lies in the fact that a nasal mask, due to its smaller size, will attract less attention for members of the public, when a person is wearing the mask. The air treatment device, with this nasal mask, can thus be used easier in spaces with other people, without disturbing, frightening or intimidating the other people.

Besides being smaller, the nasal mask may further appear to look like a communication headset. These headsets are known throughout, which makes the mask to have a subtle appearance, substantially out of sight for other people.

The nasal mask may comprise a central chamber, onto which two nose plugs are arranged, which are each configured to be inserted in a nostril of the person. The chamber of the nasal mask may be connected to a first end of a duct, and serves as a manifold, dividing the incoming flow of air into a flow for each of the nostrils.

The duct may be adapted to extend along the cheek of the person, wherein the first end of the duct is arranged near the nose of the person and wherein a second, opposing end of the duct is arranged near the ear of the person. At the second end of the duct, a securing element is arranged, with which the nasal mask may be secured to the head of the person.

The hose of the device may be connected to the duct at its second end, such that, when the mask is arranged on the head of the person, the hose extends from the air pump towards the side of the persons head.

In an embodiment, the device comprises a hose to guide the flow of air from the pump towards the breathing mask. With the hose, the flow of air may be transported across a larger distance between the breathing mask and the air pump. In this embodiment, the air pump may therefore be arranged at a distance from the breathing mask in order to prevent nuisance from the air pump.

In a further embodiment, the hose comprises a first channel to guide the flow of air and a second channel, parallel to the first channel and which extends between the interior of the breathing mask and the pressure sensor. The first channel thereby serves to guide the flow of air form the air pump towards the breathing mask. The second channel extends along the first channel, for example within a single, shared hose casing.

The second channel is configured to fluidly link the interior of the mask with the pressure sensor, when the pressure sensor is set at a distance from the mask, for example near the air pump and/or the control unit. The second channel provides that an air pressure in the interior of the mask will be transferred the pressure sensor, and that the measured pressure with the pressure sensor corresponds to the actual pressure level in the interior of the mask.

Preferably, a cross section of the first channel is substantially larger than a cross section of the second channel. With a large cross section of the first channel, a high amount of air may be transported towards the breathing mask, with a low amount of resistive pressure. The diameter of the first channel may, in an embodiment, for example be in the range between 8 and 20 mm, whereas the diameter of the second channel is in the range between 0.5 and 2 mm.

With a narrow second channel, however, the volume of the second channel is relatively low. In case the pressure in the interior of the mask, on one end of the second channel, is reduced, this pressure drop is rapidly transferred to the pressure sensor at the other end of the second channel, due to the low volume and corresponding inertia of the air in the second channel.

In a further embodiment, the second channel is incorporated in a wall of the first channel. The second channel may thereby spirally extend around the first channel, wherein the second channel is integrated in the wall of the first channel or wherein the second channel spirally extends around the outer surface of the first channel, being fixedly connected to the first channel.

In an alternative embodiment, the pressure sensor may be arranged in the breathing mask to measure the pressure in the interior of the mask directly. In this case, no second channel needs to be present between the pressure sensor and the mask. Accordingly, the hose will comprise the first channel, for providing the flow of air to the person, but will lack the second channel. An electronic connection, such as a wire, between the pressure sensor and the control unit may, however, extend within the hose, along the first channel.

In another alternative embodiment, the pressure sensor may be arranged in an interior of the first channel, preferably near the air pump. In case a diameter of the first channel is sufficiently large, it has been found that the pressure throughout the first channel substantially corresponds to the pressure in the interior of the mask. As such, the second channel may no longer be required for providing a fluid link between the interior of the mask and the pressure sensor.

In an embodiment, the air treatment device comprises a humidifying device. The humidifying device is configured to increase the humidity of the flow of air that is supplied to the person. The humidifying device may thereto comprise a water reservoir and a nozzle that exits in the hose in order to discharge water in the air that is supplied towards the breathing mask. Preferably, the nozzle is configured to spray the water into a plurality of minuscule droplets, in order to spread the water throughout the air.

The humidifying device may, for example, be arranged adjacent the air pump and may be configure to increase the humidity of the air that has been pumped. Alternatively, the humidifying device may be arranged adjacent the breathing mask, in order to reduce the length of the section of the hose that is in contact with the humidified air.

In an embodiment, the breathing mask comprises an outlet valve to allow, in dependence of a pressure difference between the interior of the breathing mask and the ambient air, a flow of air from the interior of the mask towards the ambient air. The outlet valve is thereby configured to discharge air, which has been exhaled by the person, out of the mask.

With the outlet valve, recirculation of the air is minimized and it is minimized as well that the person would inhale air that has already been inhaled and exhaled. The discharge of exhaled air through the outlet valve further provides that the exhaled air does not need to be discharged through the hose. It is thereby minimized that any exhaled gasses will contaminate the fresh air that is present in the hose, to be inhaled by the person.

A further advantage of this outlet valve lies in the fact that the person may both breathe in and out through his nose. With other types of breathing masks, such as masks that cover both nose and mouth, exhaling through the nose would become difficult, due to an uncomfortable increase in air pressure.

The outlet valve is a non-return valve, which means that a fluid passage there through is only allowed in one flow direction, whereas a fluid passage in the opposing flow direction is prevented. The outlet valve is thereby configured to open the fluid passage when the pressure difference is directed such, that the pressure in the interior of the mask is higher than the surrounding ambient pressure.

In an embodiment, the outlet valve is movable between a closed position, in which no air flow through the outlet valve is possible, and one or more opened positions, in which an air flow through the outlet valve is possible through an outflow opening, having a cross-sectional area. The outlet valve is biased in the closed position.

When the pressure of the ambient air is higher than the pressure in the interior of the mask, the outlet valve is arranged in the closed position, preventing an air flow from the ambient air into the interior of the mask. Since the outlet valve is biased into this closed position, a threshold pressure difference is needed to overcome this biasing closing force for opening the valve. As long as the pressure difference over the outlet valve is lower that the threshold pressure difference, the valve will thus remain in the closed position.

Accordingly, the combined operation of the air pump and the outlet valve is sufficient to maintain a substantially constant pressure difference between the interior of the mask and the ambient air. In case the pressure difference becomes too high, air may be discharged through the outlet valve and/or the air pump may be controlled to decrease the air flow. However, when the pressure difference becomes too low, the pump may be controlled to increase the flow of air in order to increase the pressure in the interior of the mask.

In an embodiment of the device, the outlet valve is dimensioned such, that when the pressure difference between the interior of the mask and the ambient air increases towards the desired pressure difference, a cross-sectional area of an outflow opening of the valve increases gradually until a pressure difference at a switch point. Furthermore, the valve is dimensioned that the cross-sectional area of the outflow opening increases steeply with a pressure difference that is higher than the desired pressure difference, beyond the switch point. This dual behaviour of the outlet valve has the advantage that the valve is configured to both let through flows with a low flow rate as well as flows with a high flow rate. An example of these flows would be a small flow during normal breathing and a large flow during heavy breathing, for example during sighing or when the person has to make a physical effort.

In a further embodiment, the valve comprises a valve element and a valve seat, wherein the valve element is, in a central portion thereof, fixedly connected to the valve seat and wherein the valve element comprises, on opposite sides of the central portion, side portions that are configured to be arranged against the valve seat.

In an embodiment, the valve element is, compared to the valve seat, relatively flexible and is configured to deform elastically when the pressure difference is applied over the valve. In the closed position, the valve element is arranged over an opening that is defined by the valve seat, and thereby covers this opening. In a central portion of the valve element, the valve element is secured to the valve seat, so that, during deformation of the valve element, this central portion remains attached to the valve seat.

The valve element may, for example, have an ellipsoid shape, which corresponds to an ellipsoid opening in the valve seat. The valve element has a somewhat larger surface area than that of the opening, so that the valve element overlaps with the valve seat. The central portion of the valve element extends along the short axis of the ellipsoid valve element. At end points of the short axis of the valve element, the valve element is connected to the valve seat.

In between end points of the long axis of the valve element and the short axis of the valve element, the side portions are defined. These side portions are not attached to the valve seat and may, under the influence of a pressure difference across the outlet valve, move away from the valve seat.

When a pressure difference is applied over the outlet valve, the pressure may push the side portions of the valve element away from the valve seat. The valve element thereby deforms, because the central portion of the valve element is secured to the valve seat, preventing it from being moved. In between the side portions of the valve element and the valve seat, the outflow opening is induced, through which the exhaled air in the interior of the mask may flow towards the ambient air. The outflow opening has a projected cross-sectional area, which is a measure for the size of the outflow opening. The cross-sectional area is dependent on the spacing between the side portions of the valve element and the valve seat, since the size of the outflow opening increases with increasing spacing between those.

In the closed position of the valve, the side portions of the valve element are thus arranged against the valve seat, preventing a flow of air through the valve. In the one or more opened positions of the valve, the side portions of the valve element are spaced from the valve seat, allowing an air flow through the outlet valve.

During operation of the device, the pump may continuously supply a small flow of air towards the mask, in order to flush the device and in particular the hose and the breathing mask thereof. The outlet valve is thereby dimensioned such, that the threshold pressure difference is less than the desired pressure difference between the interior of the mask and the ambient air. As such, it is provided that the outlet valve is in the opened position during normal operation of the device, in order to allow the flow of flushing air through the mask.

In an embodiment, the valve comprises a link element with two interconnected link arms, which extend between the side portions of the valve element, bridging the central portion of the valve element. The link element thus forms a connection between the opposing side portions of the valve element, but is not connected to the central portion of the valve element.

During opening of the outlet valve, the side portions are deformed and are bent around the central portion. The side portions are thereby moved away from their respective portions of the valve seat, but move towards each other, above the central portion of the valve element. The link element is arranged in between the side portions, and is thus compressed when the side portions are moved towards each other.

The link element serves the purpose to stiffen the valve element and to increase the force that is required to move the outlet valve from the closed position to the opened position. The link element furthermore contributes in achieving the earlier mentioned threshold pressure difference for opening the outlet valve, because the link element is configured to add stiffness to the valve element.

A first end of a first one of the link arms is connected to one of the side portions. A second, opposing end of the first link arm is connected to a first end of a second one of the link arms. Finally, a second, opposing end of the second link arm is connected to the other one of the side portions.

The link arms of the link elements may be aligned substantially parallel to a mirror axis of the valve. In the embodiment with the ellipsoid valve element, the link arms extend parallel to the long axis of the valve element and perpendicular to the short axis of the valve element. The link arms are preferably arranged in a mirror plane of the valve element, which extends through the long axis.

In an embodiment, the link arms of the link element are integrally formed with each other and integrally formed with the valve element. Preferably, a thinned section is at least arranged at the connection between the first link arm and the second link arm. By doing so, it is intended that any relative rotation between the link arms occurs at this thinned section.

Preferably, the valve element, together with the link element, is manufactured by means of an injection moulding method and is made of an elastomeric material. These elastomers provide for good deformability and are capable of withstanding large amounts of strain.

In an alternative embodiment, the link element may comprise a single link arm, which extends between the side portions, but may also comprise more than two link arms in order to provide for a more rigid connection between the side portions of the valve element.

In an embodiment, the link element is movable between a substantially straight orientation, in which the link arms are substantially aligned and in which the link element has a stiffness, and a bent orientation, in which the link arms are substantially bent and in which the link element has a substantially lower stiffness, wherein the link element is in the substantially straight orientation, when the valve is in the closed position.

In the closed position of the valve, the side portions of the valve element are arranged against the valve seat and a distance between the side portions is the largest. In this closed position of the valve, the link arms are aligned in-line, such that the link arms form a substantially straight connection between both side portions. In the middle of the link element, above the central portion of the valve element, the thinned section of the link element is arranged, forming the connection between both link arms.

In this position of the link element, the link arms provide for additional stiffness to the valve element. For opening of the valve, when a pressure difference is applied across the valve element, the link element has to deform and the link arms have to rotate with respect to each other. A deflection of the link element at the connection between the link arms is low, which means that, in this position of the link arms, the link element has a high stiffness. When the pressure difference across the valve is increased, the force on the link element is increased accordingly, such that it is deformed and that the link arms will rotate with respect to each other, around the thinned section. Once the link element has been deformed, the deflection of the thinned section rapidly increases, which rapidly reduces the stiffness of the link element and thus the stiffness of the entire valve element.

In an embodiment of the device, the outlet valve with the link element is dimensioned such that, with increasing pressure difference between the interior of the mask and the ambient air, the cross-sectional area of the outflow opening increases gradually until a pressure difference at a switch point, and that the cross-sectional area of the outflow opening increases steeply with a pressure difference beyond the switch point.

The switch point is thereby defined as the point at which the stiffness of the link element is substantially reduced and at which the opening and closing behaviour of the valve thus switches between gradual and steep.

When increasing the pressure difference across the valve, first, the side portions of the valve element are elastically deformed and become spaced from the valve seat. In the closed position of the valve, and in this opened position of the valve, the link element is in the substantially straight orientation. When the pressure difference across the valve is increased further, the side portions are deformed to a larger extent, but the link element will remain in the substantially straight orientation.

When the pressure difference, upon increasing it, reaches that of the switch point, the side portions have deformed to such an extent, that the force on the link element causes it to switch towards the bent orientation. The stiffness of the link element in the bent orientation is substantially lower than that in the substantially straight orientation, so the overall stiffness of the valve element becomes substantially lower as well when the pressure difference is higher than at the switch point.

Accordingly, the side portions of the valve element will deform to a larger extend with increasing pressure difference. As such, it is achieved that, with the link element in the bent orientation, the cross-sectional area of the outflow opening increases to a larger extend for a similar increase in pressure difference across the valve, than with the link element in the substantially straight orientation.

This switching of the link element has the advantage that the valve has a dual opening characteristic. For a low pressure difference across the valve, the outflow opening is opened slightly, whereas for a high pressure difference across the valve, the outflow opening is opened much further.

The valve is dimensioned such that the switch point lies above the pressure differences that are reached during normal breathing of the person. When the person has to breathe heavily, for example when making a large effort, the pressure difference lies above the switch point and a large flow of air may be discharged through the outlet valve, at a relative low counter pressure.

The valve therefore provides a further advantage, in that the person will experience a less constricted feeling during exhaling, since the resistive pressure of the air flowing through the opened valve is relatively low. The wearing of the mask thereby becomes less uncomfortable, when compared to the masks that are known in the art.

The configuration of this valve, and the low pressure loss through the valve, furthermore provides that a pressure accumulation in the interior mask is substantially reduced. This further reduces the risk, in particular when applied in a nasal mask, that the mask is blown away from the face of the person as a result of the pressure accumulation. In an embodiment, the valve is dimensioned such that the threshold pressure difference for opening the valve from the closed position is chosen below the desired pressure difference, for example in the range of 0-2 hPa below the desired pressure difference. During normal breathing of the person, the pressure difference across the valve remains below that of the switch point and remains low enough to allow for comfortable exhaling by the person, at least when the flow velocity of the flow of exhaled air is around a typical human value of 0.1 litres per second.

In an embodiment, the valve may be dimensioned such, that the switch point is arranged at a pressure difference that is in the range of 0-2 hPa, preferably in the range of 0.5-1 hPa above the desired pressure difference. The exhaling in the breathing mask may thereby remain comfortable, without accumulation of pressure in the interior thereof.

The above-mentioned outlet valve is not limited to be used in the air treatment device according to the present invention. The valve may also be used in other applications, which require such a dual opening characteristic.

The present invention therefore also provides a valve, which comprises a valve element and a valve seat, wherein the valve element is, in a central portion thereof, fixedly connected to the valve seat and wherein the valve element comprises, on opposite sides of the central portion, side portions that are configured to be arranged against the valve seat.

In an embodiment of the valve, it comprises a link element with two interconnected link arms, which extend between the side portions of the valve element, bridging the central portion of the valve element.

In a further embodiment of the valve, the link element is movable between a substantially straight orientation, in which the link arms are substantially aligned and in which the link element has a stiffness, and a bent orientation, in which the link arms are substantially bent and in which the link element has a substantially lower stiffness, wherein the link element is in the substantially straight orientation when the valve is in the closed position.

The present invention further provides a method for supplying filtered air to a person with a portable air treatment device, comprising the steps of:
detecting, with a pressure sensor, the pressure difference between the interior of the breathing mask and the ambient air,
controlling, with a control unit, the air pump to provide a flow of air, in dependence of the pressure difference, in order to maintain a desired pressure difference between the interior of the mask and the ambient air,
filtering, with the filtration device, the flow of air, and
guiding the flow of air towards the interior of the breathing mask.

With the method according to the invention, the air flow is increased when the actual pressure difference is below the desired pressure difference, for example when the person is inhaling. When the actual pressure difference is at the desired level or even above this level, the control unit is configured to control the air pump to reduce the flow of air. With this method, it is achieved that the device is more comfortable for the person and uses less energy.

Further characteristics and advantages of the portable air treatment device according to the invention will be explained in more detail below with reference to an embodiment which is illustrated in the appended drawings, in which:

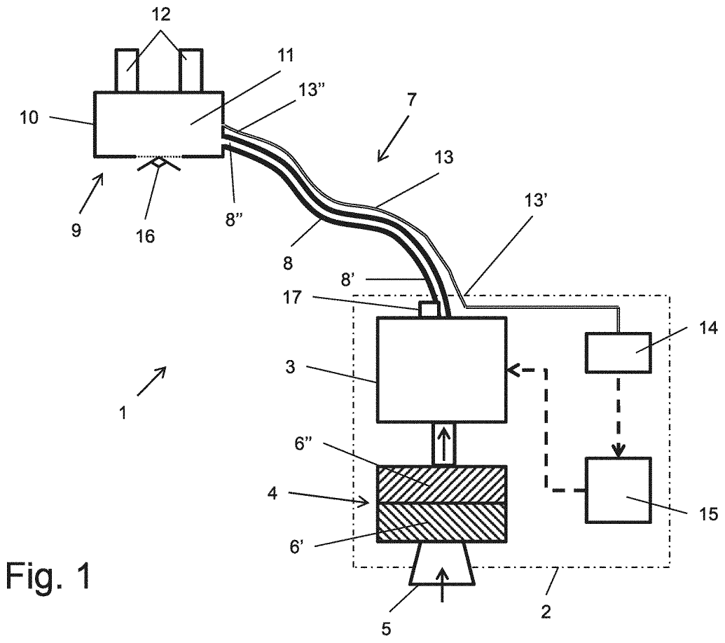

FIG. 1 schematically depicts an embodiment of the portable air treatment device according to the invention;

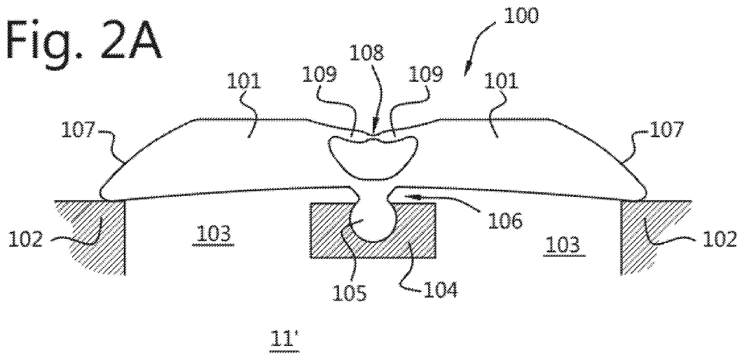

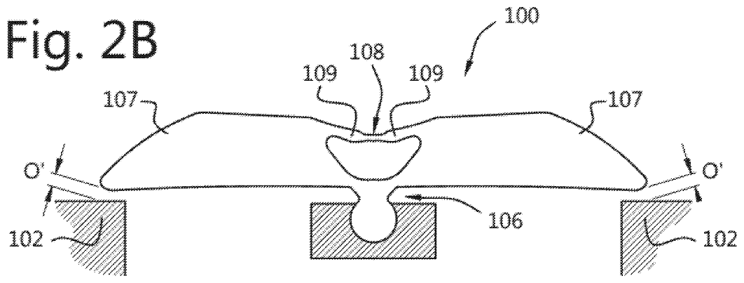

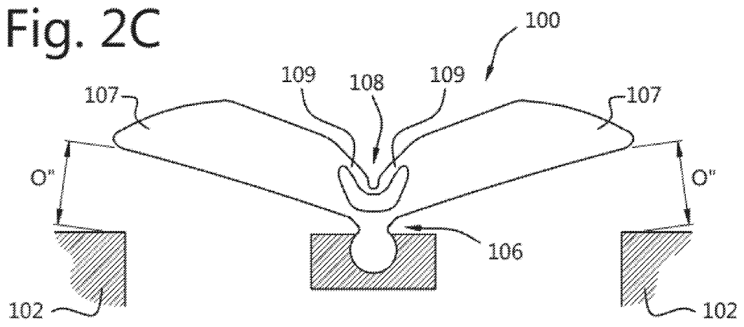

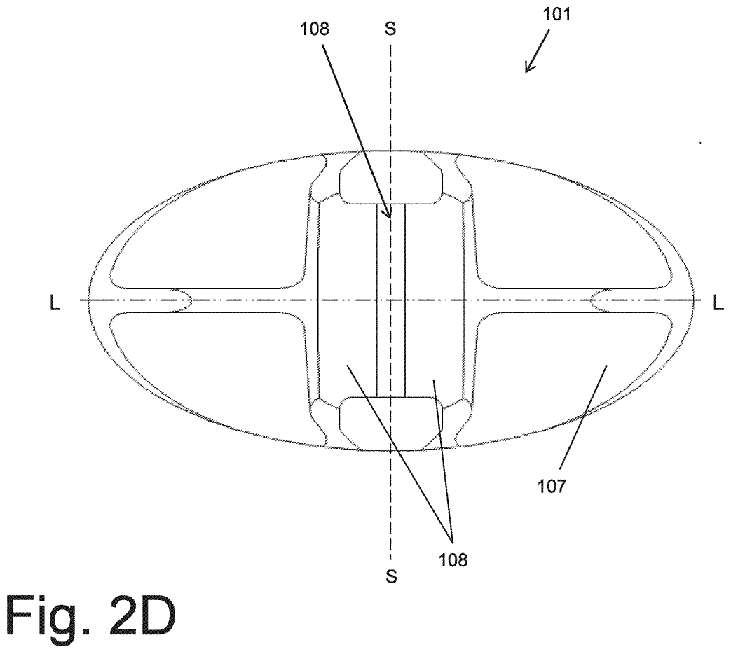

FIG. 2A schematically depicts an embodiment of an outlet valve of the device according to the invention, displayed in the closed position,

FIG. 2B schematically depicts the outlet valve of FIG. 2A in a first opened position,

FIG. 2C schematically depicts the outlet valve of FIG. 2A in a second opened position,

FIG. 2D schematically depicts a valve element of the outlet valve of FIG. 2A, and

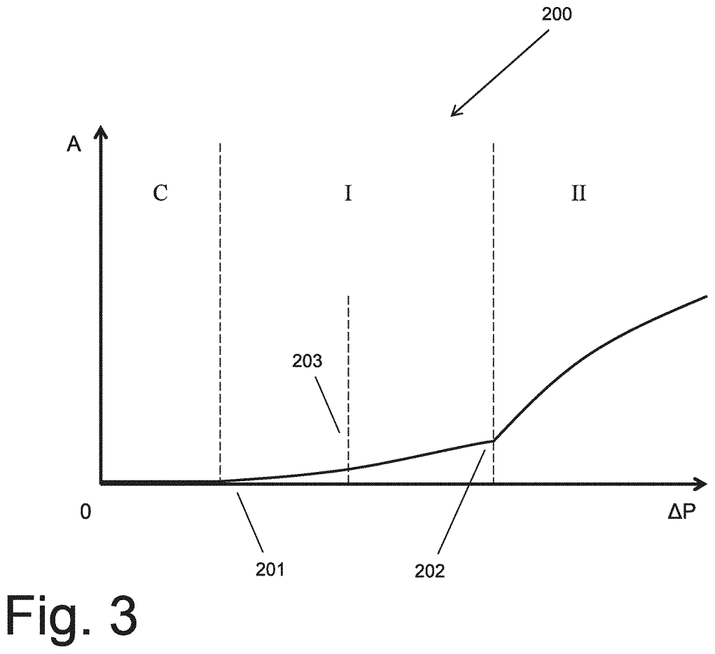

FIG. 3 schematically depicts an opening characteristic of the valve of FIGS. 2A-2C.

In FIG. 1, an embodiment of the portable air treatment device according to the present invention is schematically displayed, generally referred to with reference numeral 1. The device 1 is configured to supply a filtered flow of air to a person in order to be breathed. The device 1 comprises a housing 2 in which an air pump 3 and a filter device 4 are arranged. The air pump 3 is configured to suck in air through an inlet 5 of the device 1, which faces the ambient air in the surroundings of the housing 2. In FIG. 1, the flow of air is displayed with solid arrows.

In the present embodiment, the air pump 3 is a centrifugal pump. These pumps are known to be reliable pumps for pumping air and are configured to supply the flow at a sufficiently large flow rate and at the desired pressure level.

In the flow of air, in between the inlet 5 and the air pump 3, the filter device 4 is provided. The filter device 4 is configured to filter the flow of air, and to remove possible contaminants therefrom. Advantageously, the filter device 4 is, as in the present embodiment, arranged upstream of the air pump 3. By doing so, the flow of air is filtered before entering the air pump 3, preventing contamination of the air pump 3 by the contaminants in the flow of air.

In the present embodiment, the filter device 4 comprises two exchangeable filter elements 6 through which the flow of air is guided. A first filter element 6′ is a HEPA-filter (High Efficiency Particulate Arrestance). This air filter is configured to remove solid particles and liquids particles, or droplets from the flow of air. A second filter element 6″ is an activated carbon filter element, which is configured to remove gaseous species from the flow of air.

Besides the two filter elements 6 in the present embodiment, other types of filter elements 6, or a different amounts of filter elements 6 may be used in other embodiments of the device. Since the filter elements 6 are exchangeable, the person may select and place appropriate filter elements 6 in the filter device 4, based on the specific contaminants in the incoming flow of air.

The air pump 3 is configured to feed the flow of air, out of the housing 2, towards the person. The device 1 therefore comprises a tubular hose 7 with a first channel 8 through which the flow of air is guided. With a first end 8′ thereof, the first channel 8 is connected to the housing 2 of the device 1, for receiving the flow of air from the air pump 3.

A second end 8″ of the first channel 8, opposing the first end 8′, is connected to a breathing mask 9 of the device 1. The breathing mask 9 is configured to supply the flow of air into the nostrils of the person, and is therefore configured to be arranged at the person's head.

The first channel 8 is configured to guide the flow of air from the air pump 3, near its first end 8′, towards the breathing mask 9, at its second end 8″. The length of the hose 7, in between its ends, is furthermore chosen such, that the housing 2 of the device 1 can be arranged at a sufficient distance from the head of the person. For example, the length of the hose 7 is chosen such, that the housing 2 of the device 1 may be arranged near a waist region of the person.

The breathing mask 9 comprises a manifold 10, which is connected to the second end 8″ of the first channel 8. Within the manifold 10, an interior 11 of the breathing mask 9 is defined, into which the flow of air is fed from the first channel 8.

On the manifold 10, two nose plugs 12 are mounted which are each adapted to be inserted into a nostril of the person. The plugs 12 are fluidly connected to the interior 11 of the mask 9 and may comprise one or more openings in their frontal ends, in order to allow the air flow to be delivered into the nose of the person. In FIG. 1, the nose plugs 12 are displayed as cylindrical elements. However, in an alternative embodiment, the plugs may comprise gripping means in order to clamp the plugs within the nostrils of the person.

The hose 7 of the device 1 comprises a second channel 13 which extends between the housing 2 and the breathing mask 9 as well. A first end 13′ of the second channel 13 extends from within the housing 2, and an opposing, second end 13″ of the second channel 13 is fluidly connected to the interior 11 of the mask 9. The second channel 13 is configured to fluidly connect the interior 11 of the mask 9 with a pressure sensor 14 in the housing 2, such that an air pressure in the interior 11 of the mask 9 is also present at the pressure sensor 14.

The cross-sectional area of the first channel 8 is substantially larger than the cross-sectional area of the second channel 13. The first channel 13 may thereby be optimally dimensioned to guide a relatively large flow of air, with a relatively low pressure drop along the channel 8. The second channel 13 is, however, dimensioned to rapidly transmit a pressure gradient along its length, such that a difference in air pressure between its first end 13′ and its second end 13″ is minimized.

The pressure sensor 14 is configured to measure the air pressure difference between the interior 11 of the breathing mask 9 and the ambient air and is configured to transmit an electronic signal, representative for the pressure in the interior of the mask. In FIG. 1, the electronic signals are schematically displayed as dotted arrows.

In the present embodiment, the pressure sensor 14 is arranged within the housing 2. As such, the breathing mask 9 is kept free of electronic components and solely comprises mechanical elements. In an alternative embodiment, however, the pressure sensor may also be arranged within the interior of the breathing mask. The pressure can then be measured locally and can be transferred towards the housing as an electronic signal. By doing so, the device would no longer require a second channel in between the breathing mask and the housing.

The pressure sensor 14 in the present embodiment of the device 1 is configured to transmit the signal of the pressure towards a control unit 15 of the device 1. The control unit 15 is thereby configured to control the air pump 3 in dependence of the pressure difference between the interior 11 of the mask 9 and the ambient air. By controlling the pump 3, the control unit 15 is configured to adjust the flow of air that is provided by the pump 3.

The device 1 is configured to maintain a desired pressure difference between the interior 11 of the mask 9 and the ambient air. As such, this pressure difference is kept substantially constant, wherein the control unit 15 is configured to control the pump to adjust the flow air to compensate for the inhaling or exhaling of the person.

The device 1 further comprises an outlet valve 16, which is arranged in the manifold 10 of the breathing mask 9. The valve 16 is configured to provide a fluid connection between the interior 11 of the mask 9 and the ambient air, in dependence of a pressure difference across the valve 16.

The device 1 further comprises a humidifying device 17, which is arranged in the housing 2 and adjacent the first end 8′ of the first channel 8. The humidifying device 17 comprises a fluid reservoir, a pump and a nozzle that exits in the first channel 8. The humidifying device 17 is configured to supply water into the flow of air that is fed through the first channel 8. The pump is thereby configured to pump water from the fluid reservoir towards the nozzle, where the water is sprayed and brought into the flow of air in the first channel 8, in order to increase the humidity of the air that is fed towards the breathing mask 9.

A further embodiment of the valve is schematically displayed in FIGS. 2A-2C, in which, for clearness, the valve is displayed in substantial isolation. In this embodiment, the outlet valve is generally referred to with reference numeral 100.

In FIG. 2A, the outlet valve 100 is displayed in its closed position. The valve 100 comprises a flexible valve element 101, which is, at least in the closed position of the valve 100, configured to close off a fluid passage between an interior 11′, such as an interior 11 of a breathing mask 9, and an exterior, such as the ambient air. In the displayed closed position of the valve 100, the valve element 101 is arranged against a valve seat 102 of the valve.

The valve 100 is a non-return valve and is configured to provide a fluid path there-through in one flow direction, while preventing a fluid path in an opposing second flow direction. The fluid path is provided when the valve 100 is arranged in one or more opened positions, whereas the fluid path is prevented in the closed position of the valve 100.

The present embodiment of the valve 100 is configured to allow a flow of air from the interior 11′ towards the exterior. This outlet flow will occur when the pressure in the interior 11′ is higher than the pressure in the exterior.

In the valve seat 102, an ellipsoidal opening 103 is provided, which is, at least in the displayed closed position of the valve 100, closed-off by the valve element 101. A fixing portion 104 of the valve seat 102 extends across the opening 103, comprising a slot, in which a chord 105 of the valve element 101 is arranged. With the chord 105, a central portion 106 of the valve element 101 is fixedly connected to the valve seat 102, preventing relative movements between them.

The valve element 101 comprises side portions 107 on opposite sides of the central portion 106. The side portions 107 are, at least in the closed position of the valve 100, configured to be arranged against the valve seat 101 for preventing the air flow through the valve 100.

The valve 100 comprises a link element 108, which extends between the side portions 107 of the valve. The link element 108 comprises two link arms 109, which are interconnected and, together, bridge the central portion 106 of the valve element 101.

In FIG. 2D, a top view on the valve element 101 of the outlet valve 100 is displayed. In the figure, the valve element 101 is an ellipsoid element, which a long axis (L-L), defining a long mirror plane of the valve element 101, and short axis (S-S), defining a short mirror plane of the valve element 101. On both sides of the short axis (S-5), a side portion 107 of the valve element 101 is arranged.

In the closed position of the valve 100, as displayed in FIG. 2A, the link arms 109 are substantially aligned with respect to each other and the link element 108 is in a substantially straight orientation. In the embodiment, the arms 109 are integrally connected to each other and to the side portions 107. At the connection between the link arms 109, a thinned portion is provided, in which the arms 109 have a cross-section that is substantially smaller than a normal cross-section of the arms 109.

The outlet valve 100 is biased in the closed position, as displayed in FIG. 2A, when no pressure difference is applied across the valve 100. A threshold pressure difference across the valve 100 would be required to overcome a biasing closing force, when opening the valve 100. In case a pressure difference, below the threshold pressure difference, is present over the outlet valve 100, the valve 100 will remain in the closed position.

In FIG. 2B, the valve 100 is displayed in a first opened position. In the first opened position, the side portions 107 of the valve are spaced from the valve seat 102 and an outflow opening (O′) is provided in between them at each side portion 107. The outflow opening (O′) has a cross-sectional area, being dependent on a spacing distance between the side portions 107 and the valve seat 102.

In the first opened position of the valve 100, the side portions 107 have been elastically deformed with respect to their shape in the closed position of the valve 100. Under the influence of a pressure difference across the valve 100, the side portions 107 are elastically bent such that the outflow opening (O′) is created between the side portions 107 and the valve seat 102.

In the first opened position, the link arms 109 are, just like in the closed position, substantially aligned. In this orientation of the arms 109, the link element 108 between the side portions 107 of the valve is configured to provide a relatively large amount of stiffness to the valve element 101. Accordingly, the outflow opening (O′) of the outlet valve 100 is mainly the result of deformation of the side portions 107 themselves.

When the pressure difference across the valve 100 is further increased, with respect to the value for which the valve 100 is shown in FIG. 2B, the side portions 107 will be further bent away from the valve seat 102 and the outflow opening (O′) is gradually increased with increasing pressure difference.

In FIG. 2C, the valve 100 is displayed in a second opened position. In the second opened position, the side portions 107 have been further spaced from the valve seat 102. As such, an outflow opening (O″) in the second opened position is substantially larger than the outflow opening (O′) in the first opened position in FIG. 2B.

In the second opened position, not only the side portions 107 themselves have been elastically deformed, moreover, the central portion 106 of the valve element 101 has been deformed, causing the side portions 107 to have been rotated around the central portion 106, with respect to the valve seat 102.

The link element 108, in between the side portions 107, has been deformed as well as a result of the rotation. In the second opened positon, the link element 108 is in a bent orientation, in which the link arms 109 are substantially bent with respect to each other. The link element 108 is adapted such, that the bending between the arms 109 occurs in the thinned portion as a result of local stress concentrations.

In the bent orientation, the link element 108 has a stiffness that is substantially lower than the stiffness in its substantially straight orientation, corresponding to the closed position of the valve 100, as displayed in FIG. 2A. The stiffness of the entire valve element 101 will, as a result of the reduced contribution by the link element 108 in the bent orientation, be substantially lower than the stiffness of the valve element 101 with the link element 108 in the substantially straight orientation. A result of the lower stiffness is that, outgoing from the depicted second opened position of the valve 100, the outflow opening (O″) will increase steeply with an increase in pressure difference across the valve 100.

In FIG. 3, an opening characteristic of the valve 100 of FIGS. 2A-2C is schematically depicted, referred to with reference numeral 200. In the opening characteristic 200, the opening behaviour of the outlet valve 100 is displayed as a function of a pressure difference (ΔP) that is applied across the valve 100.

On the x-axis of the characteristic 200, this pressure difference (ΔP) across the valve 100 is displayed. A positive pressure difference (ΔP) thereby corresponds to a pressure difference in which, when the valve 100 is mounted in the breathing mask 9, the pressure in the interior 11 of the mask is higher than the pressure of the exterior.

On the y-axis of the characteristic 200 in FIG. 3, the cross-sectional area of the 15 outflow opening (O′, O″) of the valve is displayed, referred to with (A). The cross-sectional area (A) corresponds to a maximum possible flow rate through the valve 100. In the characteristic 200, it is displayed that a relationship exists between the pressure difference (ΔP) across the valve 100 and the cross-section area (A) of the outflow opening (O′, O″).

The characteristic 200 is separated into three vertically separated regions (C, I. II). For low pressure differences (ΔP), the opening characteristic 200 is in the region (C) on the left, which corresponds to the closed position of the valve 100, as displayed in FIG. 2A. The valve 100 is biased into the closed position, at least when the pressure difference (ΔP) across the valve 100 equals zero. Upon increasing the pressure difference (ΔP), the valve 100 remains in the closed position until a threshold pressure difference 201 has been reached.

At the threshold pressure difference 201, the pressure difference (ΔP) across the valve 100 becomes sufficiently high to overcome the biasing closing force and to bring the valve 100 in the first opened position, as is displayed in FIG. 2B.

When the valve 100 is in the first opened position, as is displayed in the middle region (I) of the characteristic 200, the cross-sectional area (A) of the outflow opening (O′) gradually increases up to a pressure difference (ΔP) in a switch point 202 in the characteristic 200. This gradual increase in cross-sectional (A) is caused by a gradual increase in the outflow opening (O′) as a result of the elastic deformation of the side portions 107.

As long as the pressure difference (ΔP) across the valve 100 is below that in the switch point 202, the opening characteristic 200 is in the left region (C) or in the middle region (I) and the link element 108 of the valve, extending between the side portions 107, is in its substantially straight orientation.

When the pressure difference (ΔP) across the valve 100 is increased past the pressure difference in the switch point 202, the link element 108 will bend and will move towards its bent orientation. The additional stiffness of the valve element 101, provided by the link element 108 in its substantially straight orientation, is thereby lost and the central portion 106 of the valve will deform, causing a rotation of the side portions 107.

In the present embodiment, the device is configured to maintain a desired pressure difference 203 between the pressure in the interior of the breathing mask and the ambient air in the range of 1-6 hPa, preferably in the range of 3-5 hPa, for example at 4 hPa.

In the present embodiment, the valve 100 has been dimensioned such, that the threshold pressure difference 201, at which the valve 100 is brought towards the first opened position, is below the desired pressure difference, for example in the range of 0-2 hPa below the desired pressure difference 203, such that a small amount of air is continuously discharged through the valve 100 with which the device, in particular a hose and a breathing mask of the device, may be flushed to prevent contaminations.

The valve 100 has been dimensioned such, that the switch point is arranged at a pressure difference that is in the range of 0-2 hPa, preferably in the range of 0.5-1 hPa, for example at 0.7 hPa above the desired pressure difference 203.

With a pressure difference (ΔP) above the pressure difference in the switch point 202, the opening characteristic 200 is in the right region (II) and the cross-sectional area (A) of the outflow opening (O″) increases steeply with the increasing pressure difference (ΔP). The right region (II) in the characteristic 200 furthermore corresponds to the second opened position of the valve 100, which is displayed in FIG. 2C.

It is remarked that application of the above-mentioned embodiment of the outlet valve is not limited to breathing masks, but that the outlet valve may be applied in various different devices for controlling an outflow.

1-17. (canceled)

18. A portable air treatment device to supply filtered air to a person, comprising:
an air pump to provide a flow of air,
a filter device to filter the flow of air,
a breathing mask configured to supply the flow of air to the person, and
a control unit configured to control the pump for adjusting the flow of air,
wherein the air treatment device comprises a pressure sensor to transmit a signal that is representative for the pressure difference between the interior of the breathing mask and the ambient air,
wherein the control unit is configured to control the pump for adjusting the flow of air in order to maintain a desired pressure difference between the pressure in the interior of the breathing mask and the ambient air, and
wherein the breathing mask comprises an outlet valve to allow, in dependence of a pressure difference between the interior of the breathing mask and the ambient air, a flow of air from the interior of the mask towards the ambient air.

19. The device according to claim 18, wherein the outlet valve is movable between a closed position, in which no air flow through the outlet valve is possible, and one or more opened positions, in which an air flow through the outlet valve is possible through an outflow opening, having a cross-sectional area, wherein the outlet valve is biased in the closed position.

20. The device according to claim 18, wherein, with increasing pressure difference between the interior of the mask and the ambient air:
the cross-sectional area of the outflow opening increases gradually until a pressure difference at a switch point, and
the cross-sectional area of the outflow opening increases steeply with a pressure difference beyond the switch point.

21. The device according to claim 19, wherein the valve comprises a valve element and a valve seat, wherein the valve element is, in a central portion thereof, fixedly connected to the valve seat and wherein the valve element comprises, on opposite sides of the central portion, side portions that are configured to be arranged against the valve seat.

22. The device according to claim 21, wherein the valve comprises a link element with two interconnected link arms, which extend between the side portions of the valve element, bridging the central portion of the valve element.

23. The device according to claim 22, wherein the link element is movable between a substantially straight orientation, in which the link arms are substantially aligned and in which the link element has a stiffness, and a bent orientation, in which the link arms are substantially bent and in which the link element has a substantially lower stiffness, wherein the link element is in the substantially straight orientation when the valve is in the closed position.

24. The device according to claim 21, wherein:
in the closed position of the valve, the side portions of the valve element are arranged against the valve seat, and
in the one or more opened positions of the valve, the side portions of the valve element are spaced from the valve seat.

25. The device according to claim 20, wherein:
when the pressure difference is lower than at the switch point, the link element is in the substantially straight orientation, and
when the pressure difference is higher than at the switch point, the link element is in the bent orientation.

26. The device according to claim 23, wherein:
when the pressure difference is lower than at the switch point, the link element is in the substantially straight orientation, and
when the pressure difference is higher than at the switch point, the link element is in the bent orientation.

27. The device according to claim 18, wherein the filter device is exchangeable.

28. The device according to claim 18, further comprising a humidifying device, which is configured to increase the humidity of the flow of air that is supplied to the person

29. The device according to claim 18, wherein the breathing mask is a nasal mask, preferably a sealing nasal mask, which is configured to be at least partially inserted in the nostrils of the person.

30. The device according to claim 18, wherein the air pump comprises a motor and wherein the control unit is configured to control the motor by means of field-oriented control.

31. The device according to claim 18, comprising a hose to guide the flow of air from the pump towards the breathing mask.

32. The device according to claim 31, wherein the hose comprises a first channel to guide the flow of air and a second channel, which is parallel to the first channel and extends between the interior of the breathing mask and the pressure sensor, wherein a cross section of the first channel is preferably substantially larger than a cross section of the second channel.

33. A method for supplying filtered air to a person with the portable air treatment device according to claim 18, comprising the steps of:
detecting, with the pressure sensor, the pressure difference between the interior of the breathing mask and the ambient air,
controlling, with a control unit, the air pump to provide a flow of air in dependence of the pressure difference in order to maintain a desired pressure difference,
filtering, with the filtration device, the flow of air, and
guiding the flow of air towards the interior of the breathing mask.
